(19) United States
(12) Patent Application Publication
(10) Pub. No.: US 2026/0072936 A1
(43) Pub. Date: Mar. 12, 2026

(54) TARGET PREDICTION METHOD AND SYSTEM

(71) Applicant: LG MANAGEMENT DEVELOPMENT INSTITUTE CO., LTD., Seoul (KR)

(72) Inventors: Kyung Hoon BAE, Seoul (KR); Woo Hyung LIM, Seoul (KR); Hyeok Jun CHOE, Seoul (KR); Won Bin AHN, Seoul (KR); Eui Soon KIM, Seoul (KR); Ji Won CHA, Seoul (KR)

(21) Appl. No.: 19/390,498

(22) Filed: Nov. 15, 2025

Related U.S. Application Data
(63) Continuation of application No. PCT/KR2025/002885, filed on Mar. 4, 2025.

(30) Foreign Application Priority Data
Mar. 4, 2024 (KR) 10-2024-0030945
Mar. 4, 2024 (KR) 10-2024-0030946

(51) Int. Cl. G06F 16/25; G06F 16/242; G06F 16/28

(52) U.S. Cl. CPC G06F 16/258; G06F 16/243; G06F 16/285

(57) ABSTRACT

A predictive generation method for predicting a future outlook of a target performed by a computing device or a processor may collect related structured and unstructured data when a user requests predictive generation, analyze the relationship between the target and a variable affecting the target at a semantic level, and compute a target outlook of a future.

### CROSS-REFERENCE TO RELATED APPLICATIONS

This application is a continuation of International Patent Application No. PCT/KR2025/002885, filed on Mar. 4, 2025, which claims the benefit of and priority to Korean Patent Application No. 10-2024-0030945, filed on Mar. 4, 2024, and Korean Patent Application No. 10-2024-0030946, filed on Mar. 4, 2024, the entire disclosures of which are hereby incorporated herein by reference in their entireties.

### BACKGROUND

### Technical Field

The present disclosure generally relates to a method and system for predicting a target based on relationship information between a target influence variable and a target at a semantic level.

### Related Art

Recently, with the emergence of pre-trained language models (e.g., Large Language Pretraining models, LLMs) for large-scale general domain data, various tasks that were previously processed manually are being replaced by artificial intelligence-based technologies.

In particular, the technologies that perform future prediction tasks using large-scale language models are an interesting and rapidly developing technology field, and are called future-casting.

The future-casting may refer to the use of sophisticated algorithms to predict future trends, events, or behaviors, and may be applied to various fields, from weather pattern prediction to market trend prediction and even social or political change prediction.

Machine learning, a subset of artificial intelligence, may play a pivotal role in the future-casting process. Some key aspects and technologies that machine learning models may replace in the future-casting are as follows.

Tasks that predict future events may be performed using past data. The machine learning models may identify patterns in large-scale data sets and use the pattern to make predictions. For example, in the financial sector, the machine learning models may predict stock market trends, and in the medical sector, the machine learning models may predict disease outbreaks.

Time series analysis tasks are possible in forecasting fields such as meteorology, economics, and resource management. The machine learning models may analyze data points collected at successive time intervals to predict future points in the series.

In the future-casting, natural language processing (NLP) may be used to analyze news, social media, and other text data to gauge public sentiment or predict political or social trends.

However, the accuracy of the future-casting model may be limited by the quality and quantity of data, and in particular, it is difficult to predict numerical values by simultaneously utilizing structured and unstructured data.

### SUMMARY

An aspect of the present disclosure is directed to providing a target prediction method and system that accurately predicts the short-term, mid-term, and long-term outlooks of a target based on data on various variables that may affect the target using a language model.

A target prediction method and system according to an embodiment of the present disclosure may detect a target influence variable related to a target at a semantic level, and accurately extract a feature affecting the target based on the detected target influence variable at the semantic level to predict the outlook of the target.

In addition, an aspect of the present disclosure may provide a method and system that accurately predicts a target based on structured data and unstructured data related to the target and target influence variables.

In addition, a target prediction method and system according to an aspect of the present disclosure may predict the outlook of a target from mid-to-long-term onward based on various pieces of text data such as news and reports that may serve as a basis for predicting the targets and target influence variables.

In addition, a target prediction method and system according to an embodiment of the present disclosure may clearly present a basis for predicting a target outlook based on the target influence variables and features thereof.

Further, a target prediction method and system according to an embodiment of the present disclosure may analyze target influence variables that affect a target at a semantic level and provide a basis for the outlook of the target based on causal relationship with the features of the target influence variables.

An embodiment of present disclosure relates to a target prediction method for predicting a future outlook of a target performed by a processor of a computing device, wherein the method includes: receiving a target prediction request from a user; determining a target prediction element to be predicted in the received target prediction request; searching for a target outlook report for the target of the determined target prediction element, and generating relationship information between the target and a target influence variable at a semantic level based on the searched target outlook report; filtering structured data of a feature related to the target influence variable and unstructured data of a text document related to the target influence variable based on the target influence variable of the generated relationship information; computing a target outlook of a future based on the filtered structured data and unstructured data; generating a basis of the computed target outlook as the relationship information at a feature level; and providing the user with the computed target outlook and the relationship information at the feature level.

In this connection, the reception of the target prediction request from the user may include: providing a chat interface to the user and receiving a text containing the target prediction request; and contextually analyzing the received text to detect a context indicating the target prediction request.

In addition, the determination of the target prediction element may further include performing named entity recognition on the text containing the target prediction request and determining keywords representing the target as the target prediction element, a total outlook period, and a prediction unit period.

In this connection, the determination of the target prediction element may further include listing a plurality of recognized target keywords and providing the same for the user to select when target keywords of a generic concept and target keywords of a specific concept for the target of the target prediction element are recognized in plural.

In addition, the generation of the relationship information may include: defining the target influence variable that affects the target at the semantic level; and generating a causal relationship graph as the relationship information with names of each defined target influence variable as node names.

In addition, the generation of the relationship information may further include indicating a sequence relationship between the target influence variables represented by each node of the causal relationship graph using arrows.

In addition, the filtration of the structured data of the feature and the unstructured data of the text document related to the target influence variable may include: classifying features stored in a data store into the target influence variables defined at the semantic level; and generating a structured data set by combining the structured data of the features classified into the target influence variables.

In addition, the filtration of the structured data of the feature and the unstructured data of the text document related to the target influence variable may include inputting the text document into a document classification prompt template and discriminating through a language model whether the text document is a document that affects the target.

In this connection, the computation of the target outlook of the future may include: detecting the target outlook report predicting an outlook of the target from the text document; performing sentiment analysis on sentences predicting the target in the target outlook report using the language model, and classifying an outlook value of the target as positive, neutral, or negative for each target outlook report; quantifying a level of a tone of the classified sentiment and returning the same as predicted scoring data; and generating quantification data by listing the predicted scoring data of the target outlook reports in a chronological order.

In addition, the computation of the target outlook of the future may include: combining the structured data and the quantification data to generate an integrated structured data set; and inputting the generated integrated structured data set into a prediction model to output a target outlook value.

In addition, the computation of the target outlook of the future may further include regulating the target outlook value based on the relationship information between the target and the target influence variable.

In addition, the generation as the relationship information at the feature level may include generating the features of the target influence variables that serve as a basis for predicting the target outlook value as the relationship information.

In addition, the generation as the relationship information at the feature level may include generating the relationship information including numerical values of the features that affect the predicted target outlook value at one point in time.

In addition, there may be further included performing a simulation according to a received predicted environment change input when the predicted environment change input is received from the user.

In this connection, the performance of the simulation according to the received predicted environment change input may include: changing the structured data of the feature according to a change target influence variable when there is a change to the feature of the target influence variable; and re-executing a target outlook value and a process interpreting the basis based on the changed structured and unstructured data and outputting the target outlook value and basis information based on a what-if simulation.

In addition, the performance of the simulation according to the received predicted environment change input may further include detecting a case similar to a specific event occurrence and computing a target outlook value based on the detected case when the specific event occurrence is received from the user as the predicted environment change input.

An embodiment of the present disclosure relates to a server computing system that receives a target prediction request from a user computing device and performs a target prediction task, wherein the system includes: a data store that stores target prediction-related data; a memory that stores instructions and data for performing the target prediction task; and at least one processor for performing the target prediction task according to the instructions and data of the memory, wherein the at least one processor is configured to: receive a target prediction request from a user; determine a target prediction element to be predicted in the received target prediction request; search for a target outlook report for a target of the determined target prediction element, and generate relationship information between the target and a target influence variable at a semantic level based on the searched target outlook report; filter structured data of a feature related to the target influence variable and unstructured data of a text document related to the target influence variable based on the target influence variable of the generated relationship information; compute a target outlook of a future based on the filtered structure data and unstructured data; generate a basis of the computed target outlook as the relationship information at a feature level; and provide the user with the computed target outlook and the relationship information at the feature level.

A target prediction method and system according to an embodiment of the present disclosure can accurately predict a target outlook by precisely performing data preparation necessary for target prediction and predicting the target outlook based on prediction basic data acquired.

Further, a target prediction method and system according to an embodiment of the present disclosure can precisely filter structured data and unstructured data related to target influence variables after defining the target influence variables that affect targets at a semantic level.

In addition, a target prediction method and system according to an embodiment of the present disclosure can accurately predict a target outlook value through a time series prediction model by integrating structured data and unstructured data filtered as such.

Specifically, a target prediction method and system according to an embodiment of the present disclosure can quantify unstructured data, accurately filter only features related to target influence variables from structured data, and generate an integrated structured data set, thereby generating a structured data set for time series target prediction.

In addition, a target prediction method and system according to an embodiment of the present disclosure can increase the reliability of target outlook by interpreting the basis for a predicted target outlook value and providing basis data for prediction.

In addition, a target prediction method and system according to an embodiment of the present disclosure can respond to various user requests by performing simulations based on changes in the target predicted environment of a user.

### BRIEF DESCRIPTION OF DRAWINGS

FIG. 1 illustrates a block diagram for illustrating a computing system for performing a target prediction method according to an embodiment of the present disclosure.

FIG. 2 illustrates a block diagram for illustrating a computing device, which is one of the configurations of a computing system for performing a target prediction method according to an embodiment of the present disclosure.

FIG. 3 illustrates a block diagram for illustrating a computing device, which is one of the configurations of a computing system performing a target prediction method according to an embodiment of the present disclosure.

FIG. 4 is a flowchart for illustrating a method for predicting a target outlook using a machine learning model according to an embodiment of the present disclosure.

FIG. 5 illustrates a meta-architecture for performing a method for predicting a target outlook according to an embodiment of the present disclosure.

FIG. 6 is a conceptual diagram for illustrating a process for executing a target prediction task and determining causal information with target prediction variables according to an embodiment of the present disclosure.

FIG. 7 is a conceptual diagram for illustrating a process for performing data preparation based on relationship information between a target and a target influence variable according to an embodiment of the present disclosure.

FIG. 8 is a conceptual diagram for illustrating a process for converting unstructured data into quantitative data according to an embodiment of the present disclosure.

FIG. 9 is a conceptual diagram for illustrating a process for computing a target outlook by integrating structured data and quantitative data according to an embodiment of the present disclosure.

FIG. 10 is a conceptual diagram for illustrating a process for deriving a basis for a target outlook and a process for predicting an additional target outlook according to a user simulation according to an embodiment of the present disclosure.

FIG. 11 is an example of a chart for a predicted target outlook according to an embodiment of the present disclosure.

FIG. 12 is an example of a causal graph presented as basis data for a predicted target outlook according to an embodiment of the present disclosure.

FIG. 13 is another example of a causal graph presented as basis data for a predicted target outlook according to an embodiment of the present disclosure.

### DETAILED DESCRIPTION

Embodiments can impose various transformations that can have various embodiments, and specific embodiments illustrated in the drawings will be described in detail in the detailed description. The advantages, features and methods for achieving the same will become apparent from the following description of the embodiments given in conjunction with the accompanying drawings. However, the present disclosure is not limited to the embodiments described herein but may be embodied in many different forms. It will be understood that, although the terms “first”, “second”, etc., may be used herein to distinguish one component from another component, these components should not be limited by these terms. In addition, a singular expression includes a plural expression, unless the context clearly states otherwise. In addition, it should be understood that the terms such as “include” or “have” are merely intended to indicate that features, or components described in the specification are present, and are not intended to exclude the possibility that one or more other features, or components will be added.

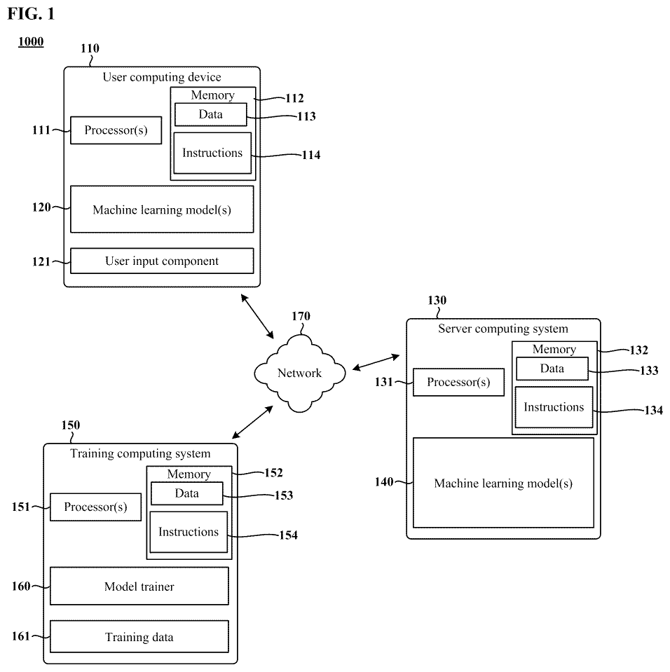

FIG. 1 illustrates a block diagram illustrating a computing system performing a target prediction method according to an embodiment of the present disclosure.

Referring to FIG. 1, a computing system or a computer system 1000 for performing target prediction according to an embodiment of the present disclosure includes a user computing device or user computer 110, a training computing system or a training computer 150, and a server computing system or a server computer 130. One or more devices and/or systems included in the computing system 1000 are communicatively connected through a network 170.

According to an embodiment of the present disclosure, 1) the user computing device 110 may perform the target prediction method using a local and/or external machine learning model 120 or using a machine learning model 140 provided by a server.

In addition, according to another embodiment of the present disclosure, 2) the server computing system 130 communicationally connected with the user computing device 110 may provide a target prediction service to the user computing device 110 on an application and/or a web according to a user request via the user computing device 110.

In addition, according to yet another embodiment of the present disclosure, 3) each of the user computing device 110 and the server computing system 130 may perform at least a portion of a method for performing target prediction to perform operations for the target prediction together by communicating each other to provide a target prediction service to a user.

In addition, according to various embodiments of the present disclosure, the user computing device 110 and/or the server computing system 130 may train the machine learning models 120 and/or 140 used to predict targets via interaction with the training computing system 150 that is communicatively connected over the network 180. In addition, the training computing system 150 may be system separate from the server computing system 130 or may be a part of the server computing system 130.

In some embodiments, the training computing system 150 may be a part of the server computing system 130 or a part of the user computing device 110.

In the following description, the user computing device 110 is connected to the server computing system 130 to execute a target prediction task, the server computing system 130 collects and analyzes data needed for target prediction using a language model by itself or from a separate server, and performs target outlook prediction based on the collected and analyzed data. However, at least a portion of the process described as being performed in the server computing system 130 may be performed in the user computing device 110.

The user computing device 110 may include any type of computing device, such as a smart phone, a mobile phone, a digital broadcasting device, a personal digital assistant (PDA), a portable multimedia player (PMP), a desktop, a wearable device, an embedded computing device, and/or a tablet PC.

The user computing device 110 includes at least one processor 111 and a memory 112. The processor 111 may comprise one or a plurality of processors electrically or communicationally connected to each other. The processors may comprise, for example, but not limited to, one or more of among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units.

The memory 112 may include one or more non-transitory and/or transitory computer-readable storage media, such as RAM, ROM, EEPROM, EPROM, flash memory devices, magnetic disks, etc., and combinations thereof, and may include web storage of servers performing storage functions of the memory on the Internet. The memory 112 may store data and/or instructions necessary for the processor 111 to perform the operation of an application for performing target prediction.

In an embodiment, the user computing device 110 may store at least one machine learning model 120. For example, the user computing device 110 may include various machine learning models such as a plurality of neural networks (for example, deep neural networks) that perform predictions on targets based on structured and/or quantitative data or other types of machine learning models, including non-linear models and/or linear models, and a combination thereof.

For example, the prediction model may store linear regression, decision tree, random forest, gradient boosting, a pre-trained language model and/or a deep learning model. The neural network may include, for instance, but not limited to, at least one of feed-forward neural networks, recurrent neural networks (for example, long short-term memory recurrent neural networks), convolutional neural networks and/or other forms of neural networks.

In addition, the user computing device 110 may store a model to be used in each process and a prompt template that serves as a basis for input to the model in order to perform at least a portion of the process performed for target prediction through a large-scale language model (LLM).

For example, the user computing device 110 may store 1) a prompt for generating a query from a user input, 2) a prompt for determining causation between a target and a target influence variable, 3) a prompt for identifying raw data associated with the determined causation, and 4) a prompt template for quantifying unstructured data.

In other words, in an embodiment, the user computing device 110 may perform target prediction based on the received data by requesting the performance of some performance stages in the target prediction task to the language model of an external server through a prompt.

In another embodiment, the target prediction task requested through the user computing device 110 may be performed in such a way that the server computing system 130 performs target prediction through at least one of the machine learning model 140 and a machine learning model of another server, thereby providing predicted data to the user computing device 110.

The user computing device 110 may include at least one input component 121 that detects or receives user input. For example, the user input component 121 may include a touch sensor (for example, a touch screen and/or a touch pad) that detects touch of a user (for example, a finger or a stylus), an image sensor that detects a motion input of a user, a microphone that detects or receives user voice input, a button, a mouse and/or a keyboard. In addition, the user input component 121 may include an interface and/or an external controller when receiving input from an external controller (for example, a mouse or a keyboard) through the interface.

The server computing system 130 includes at least one processor 131 and a memory 132. The processor 131 may comprise one or a plurality of processors electrically or communicationally connected to each other. The processors may comprise, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units.

In addition, the memory 132 may include one or more non-transitory and/or transitory computer-readable storage media, such as RAM, ROM, EEPROM, EPROM, flash memory devices, magnetic disks, etc., and combinations thereof. The memory 132 may store prompt templates for the processor 131 to perform tasks through the language model of the server computing system 130 and/or the language model of the external server, and data and instructions needed for the machine learning model 140 for future-casting.

For example, the machine learning model 140 of the server computing system 130 may include a neural network and/or other multi-layer nonlinear model for future-casting. Examples of the neural networks may include a feed forward neural network, a deep neural network, a recurrent neural network, and a convolutional neural network.

In an embodiment, the server computing system 130 may include one or more computers or computing devices. For example, the server computing system 130 may include a plurality of computers or computing devices that operate according to a sequential computing architecture, a parallel computing architecture, or combination thereof. In addition, the server computing system 130 may include the plurality of computers or computing devices connected to a network.

In an embodiment, the server computing system 130 may further include a data store computing system 1000 (hereinafter, “data store”), which is a storage for continuously storing and managing raw data that serves as the basis for future-casting for a target. The data store may include various forms of data storage, ranging from a file system to cloud storage.

For example, the data store may include: a relational database that uses a structured query language (SQL) to define and manipulate data; a not only SQL (NoSQL) database that is designed for flexibility and scalability and processes unstructured and semi-structured data; and a database of at least one of data warehouse that centralizes large amounts of data from a plurality of sources and is optimized for querying and analysis, a data warehouse that stores large amounts of raw data in their basic formats of structured, semi-structured, and unstructured data, or a local storage device or network-attached storage (NAS) that stores data in files, typically in a format that may be accessed by the computer operating system, as a system configured for report and data analysis.

The training computing system 150 includes at least one processor 151 and a memory 152. The processor 151 may comprise one or a plurality of processors electrically or communicationally connected to each other. The processors may comprise, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units. In addition, the memory 152 may include one or more non-transitory and/or transitory computer-readable storage media, such as RAM, ROM, EEPROM, EPROM, flash memory devices, magnetic disks, etc., and combinations thereof. The memory 152 may store data and instructions necessary for the processor 151 to train a future-casting model.

For example, the training computing system 150 may include a model trainer 160 that trains the machine learning model stored in the user computing device 110 and/or the server computing system 130 using various training or learning techniques, for example, but not limited to, backwards propagation of errors.

For example, the model trainer 160 may update one or more parameters of a machine learning model for future-casting using a backpropagation method based on a defined loss function.

In some embodiments, performing backwards propagation of errors may include performing truncated backpropagation through time. The model trainer 160 may perform a number of generalization techniques (for example, weight decays, dropouts, knowledge distillation, etc.) to improve the generalization capability of the future-casting models being trained.

In addition, the model trainer 160 includes computer logic configured to provide desired functionality. The model trainer 160 may be implemented in hardware, firmware, and/or software for controlling a general purpose processor. For example, in an embodiment, the model trainer 160 includes program files stored on a storage device, loaded in a memory and executed by one or more processors. In other implementations, the model trainer 160 includes one or more sets of computer-executable instructions that are stored in a tangible computer-readable storage medium such as RAM, hard disk, or optical or magnetic media.

The network 170 may include, for example, but not limited to, a 3rd generation partnership project (3GPP) network, a long term evolution (LTE) network, a 5G or 6G (5th generation or 6th generation) wireless network, a world interoperability for microwave access (WIMAX) network, Internet, a local area network (LAN), a wireless LAN, a wide area network (WAN), a personal area network (PAN), a Bluetooth network, a satellite broadcasting network, an analog broadcasting network and/or a digital multimedia broadcasting (DMB) network.

In general, communication over the network 180 may be carried via any type of wired and/or wireless connection, using various types of communication protocols (for example, TCP/IP, HTTP, SMTP, FTP), encodings or formats (for example, HTML, XML), and/or protection schemes (for example, VPN, secure HTTP, SSL).

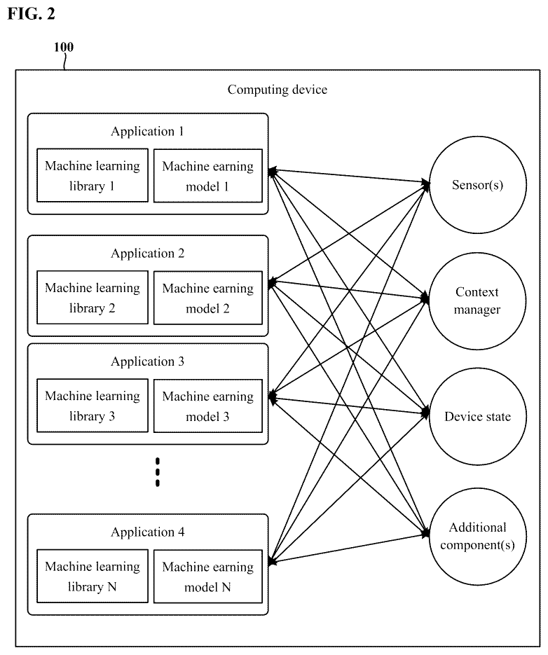

FIG. 2 illustrates of a block diagram illustrating a computing device, which is one of the configurations of a computing system performing a target prediction method according to an embodiment of the present disclosure.

Referring to FIG. 2, a computing device 100 which may be included in one or more of the user computing device 110, the server computing system 130, and the training computing system 150 each including a plurality of applications (for example, application 1 to application N, N is a natural number). Each application may include a machine learning library. For example, the application may include a future-casting application, a text messaging application, an e-mail application, a dictation application, a virtual keyboard application, a browser application, a chat-bot application, and a separate future-casting application.

In an embodiment, the computing device 100 may include the model trainer 160 for training the future-casting model, and may store and operate the future-casting model to perform a target prediction task on input data.

Each application of the computing device 100 may communicate with a number of other components of the computing device, such as, for example, one or more sensors, a context manager, a device state component, and/or additional components. In an embodiment, each application may communicate with each device component using an Application Programming Interface (API (for example, a public API). In an embodiment, the API used by each application may be specific to a relevant application.

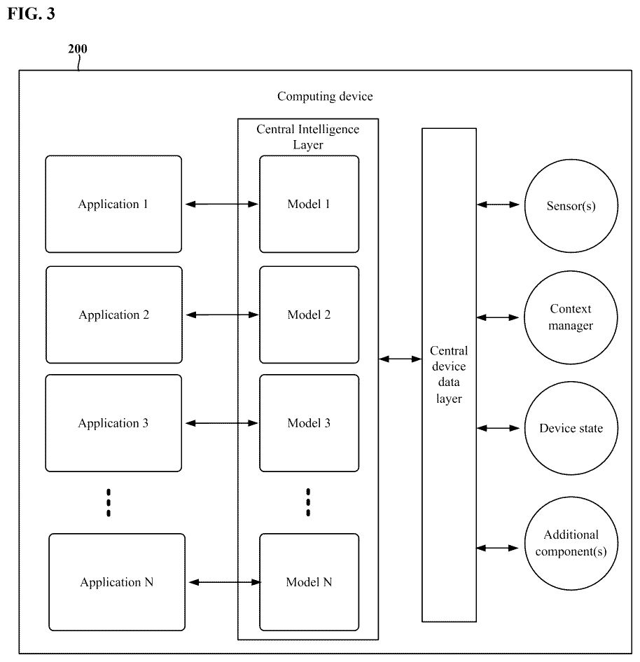

FIG. 3 illustrates a block diagram illustrating a computing device, which is one of the configurations of a computing system performing a target prediction method according to an embodiment of the present disclosure.

Referring to FIG. 3, the computing device 200 includes a plurality of applications (for example, Application 1 to Application N). Each application is in communication with a central intelligence layer. For example, the applications may include an image processing application, a text messaging application, an e-mail application, a dictation application, a virtual keyboard application, and a browser application. In an embodiment, each application may communicate with the central intelligence layer and one or more models stored therein using an API (for example, a common API across all applications).

In addition, the central intelligence layer may include prompts using a plurality of machine learning models and/or language models. For example, one or more machine learning models illustrated in FIG. 1 may be provided for each application and managed by the central intelligence layer. In certain embodiments, two or more applications may share a single machine leaning model. For example, in some embodiments, the central intelligence layer may provide a single model for all applications. In certain embodiments, the central intelligence layer may be included within an operating system of the computing device 200 or implemented differently.

The central intelligence layer may communicate with a central device data layer. The central device data layer may be a centralized data storage for the computing device 200. As illustrated in FIG. 3, the central device data layer may communicate with a number of other components of the computing device 200, such as, for example, one or more sensors, a context manager, a device state component, and/or additional components. In some embodiments, the central device data layer may communicate with each device component using an API (for example, a private API).

The embodiments discussed herein make reference to servers, databases, software applications, and other computer-based systems, as well as actions taken and information sent to and from such systems for illustration purposes only. The inherent flexibility of computer-based systems allows for a great variety of possible configurations, combinations, and divisions of tasks and functionality between and among components. For instance, the embodiments of the processes discussed herein may be implemented using a single device or component or a plurality of devices or components operating or working in combination. Databases and applications may be implemented on a single system or may be distributed across a plurality of systems. The distributed databases and applications may operate sequentially or in parallel.

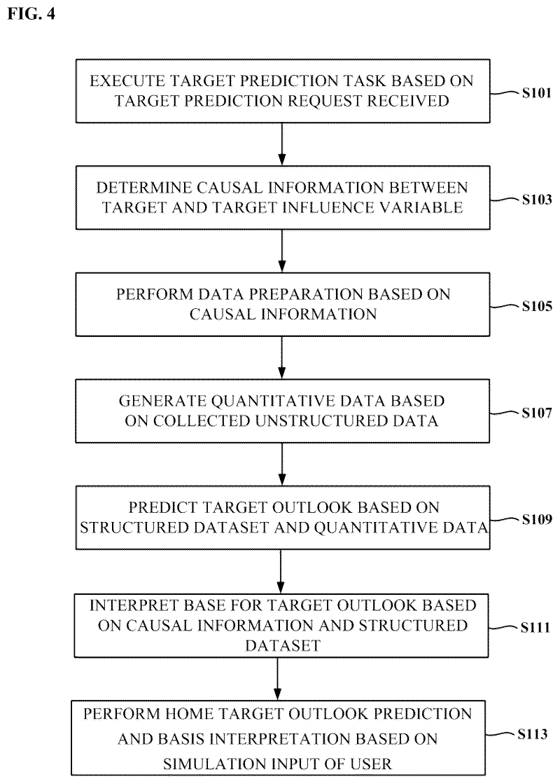

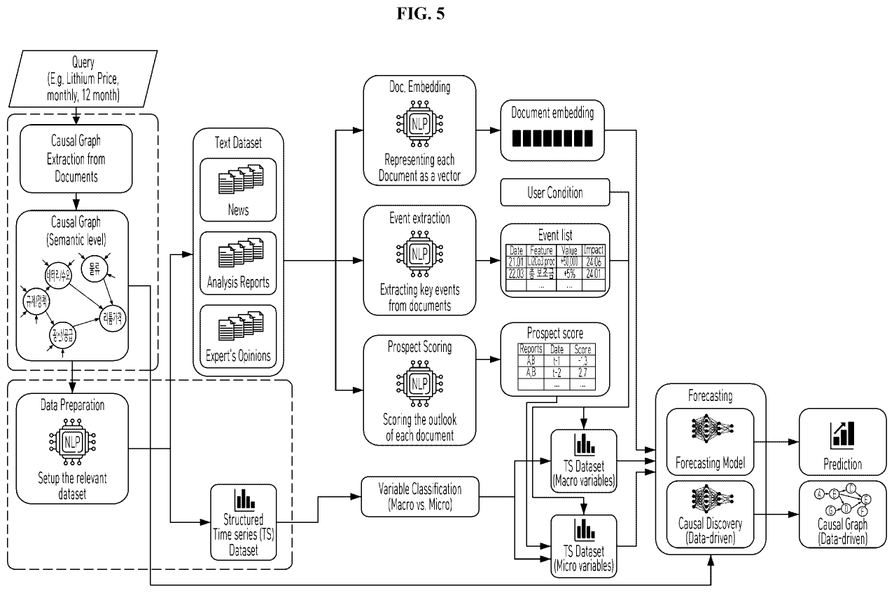

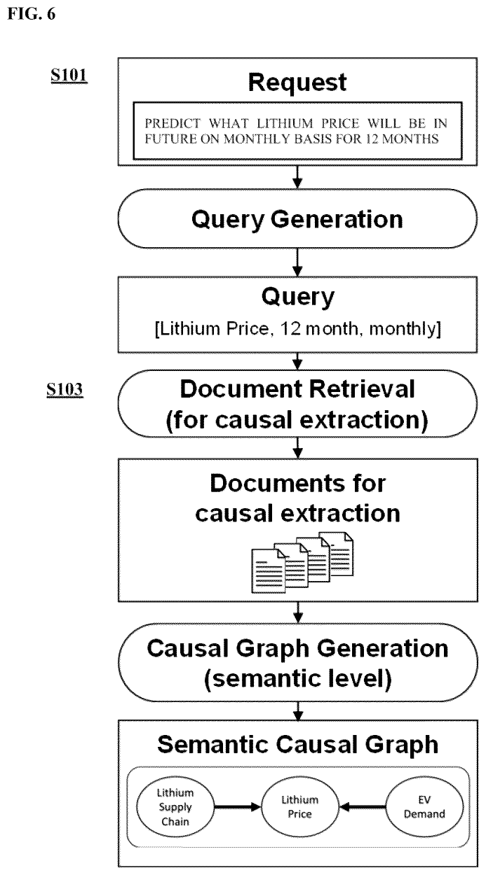

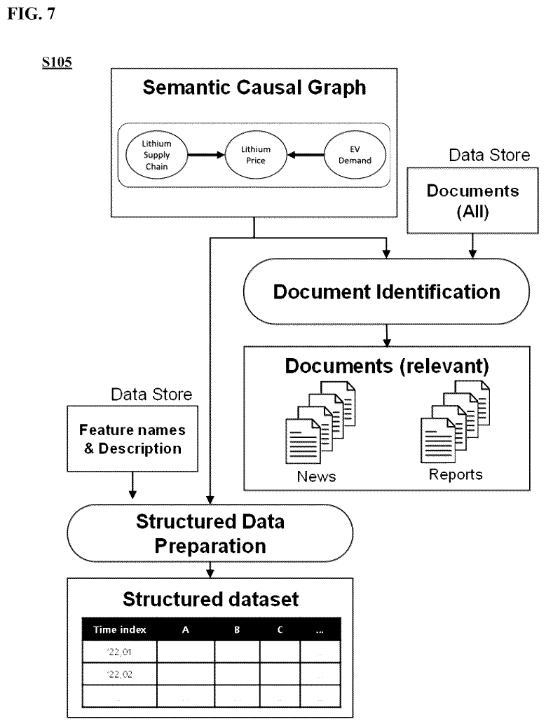

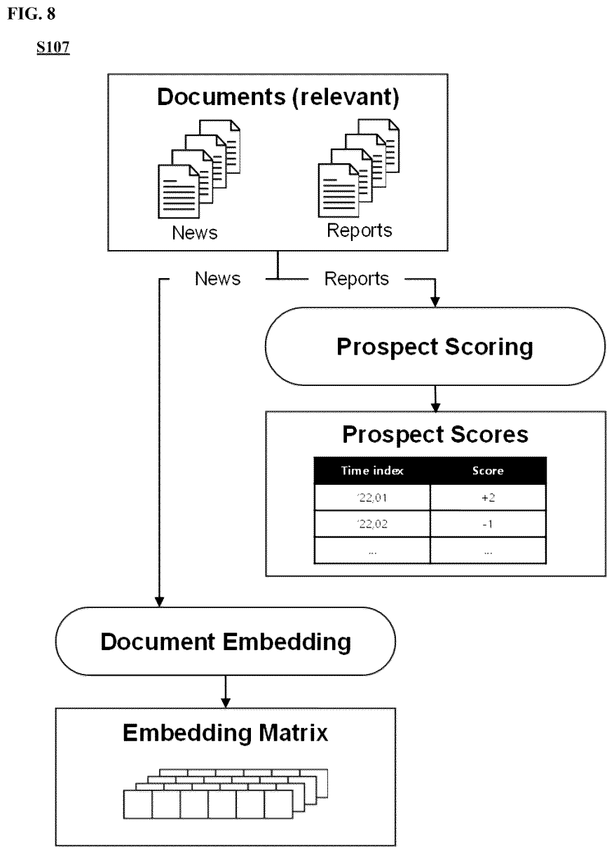

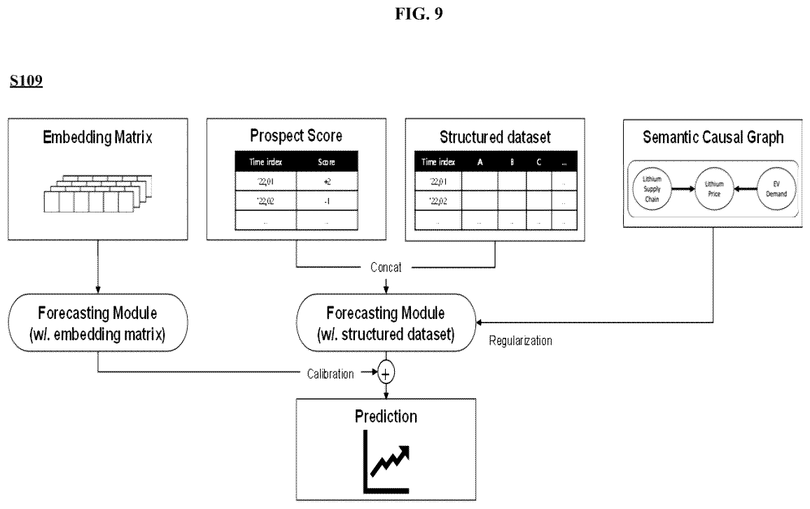

Hereinafter, a target prediction method and system in which the computing system 1000 collects raw data using a language model, analyzes the collected raw data to predict the outlook of a target, and provides causal information that serves as a basis for the outlook prediction will be described with reference to FIGS. 4 to 13.

Referring to FIG. 4, at step S101, a target prediction request may be received from the user computing device 110 of the computing system 1000, and a target prediction task may be executed according to the received target prediction request.

In an embodiment, the user computing device 110 may receive a text-based target prediction request from a user through a user interface such as a chatting interface, transmit a text including the target prediction request to the server computing system 130, and execute the target prediction task of the server computing system 130.

The server computing system 130 may execute the target prediction task by detecting a previously stored phrase for the target prediction request from a text input through the chatting interface, or by analyzing the text based on context to detect the context of the target prediction request.

In addition, the server computing system 130 may recognize a text including the target prediction request and determine a target prediction element for target prediction.

Herein, the target prediction element may include a target to be predicted, and may further include at least one of a total outlook period (e.g. a prediction length) and a prediction unit period (unit time) to be predicted.

In an embodiment, the target includes information about a numerical value that changes over time, and the prediction of the target may include predicting and computing the numerical value of a future target by predicting the total outlook period at an interval of a prediction unit period.

Specifically, the server computing system 130 may inset the text of the target prediction request into a query generation prompt template that analyzes the text of the target prediction request to determine the target prediction element, input the text into the language model, and return at least one of the target prediction elements as output from the language model to determine the target prediction element.

For example, the query generation prompt template may be configured to input “text of a target prediction request” into an interactive prediction request section as input, and to recognize values corresponding to the target, total outlook period, and unit period based on named entity recognition (NER) as an operation, and return the target, total outlook period, and unit period of the query as an output value.

As a more specific example, when a user inputs a target prediction request text, “Predict what the lithium price will be in the future on a monthly basis for 12 months,” the server computing system 130 may determine the target prediction element by inputting <<Input: Interactive prediction request “Predict what the lithium price will be in the future on a monthly basis for 12 months,” Operation: Recognizing the values corresponding to the target, total outlook period, and unit period for the input text through the NER, and generating and returning the following query, Output: Query—{Target:, Unit Period:, Total Outlook Period:}>> as a prompt to the language model to output the target prediction element as {Target: Lithium market price, Unit Period: Monthly, Total Outlook Period: 12 months}.

The server computing system 130 may provide a separate future-casting interface for inputting target prediction elements for target prediction when the target prediction elements are not specified or are abstract, and transmit the target prediction elements input through the provided future-casting interface to the server computing system 130 to execute the target prediction task. In other words, when the target is classified from a superordinate concept to a number of subordinate concepts according to the category, the server computing system 130 may list target keywords mapped to the superordinate and subordinate concepts and provide the same for a user to select.

For example, the future-casting interface may provide target keywords derived through the NER sequentially from a superordinate concept to a subordinate concept and provide the same for a user to select, so that the user can more accurately determine the target that the user wants to predict.

At step S103, when the target prediction elements are determined, the server computing system 130 may determine relationship information between the target and the target influence variable.

First, the server computing system 130 may collect target analysis data for the target. This operation may be performed by filtering data in the data store in the server computing system 130 or crawling data on the Internet.

For example, the server computing system 130 may detect target analysis data by performing keyword search based on keywords indicating the determined target. In the example, the target analysis data may be analysis reports related to the target.

Specifically, the server computing system 130 may request to search for analysis data associated with the target based on keywords of the target and return the analysis data through analysis reports based on a target analysis report collection prompt template set in advance in the language model.

More specifically, the server computing system 130 may acquire the target analysis report as output by using the target analysis report collection prompt template to <<Input: Target-Lithium market price, Operation: Searching and returning an analysis report with a title associated with the target through a keyword search>>.

In addition, the server computing system 130 may detect target influence variables that affect the target from the collected target analysis data, and analyze and generate relationship information between the target and the target influence variable.

In an embodiment, the relationship information may include information on target influence variables that affect the future prediction of the target, and information on the relationship between the target influence variables and the target.

More specifically, the information on the target influence variables may refer to information defining target influence variables at a semantic level, and the information on the relationship between the target influence variables and the target may refer to causal relationships and influence proportions and weights between targets and target influence variables and between target influence variables.

Hereinafter, the relationship information between the target and the target influence variable will be referred to as causal information.

In an embodiment, the server computing system 130 may analyze a semantic causal graph as target-target influence variable associative relationship information at a semantic level based on the collected target analysis data to generate causal information.

To this end, in an embodiment, the server computing system 130 may perform a topic-relevant terms recognition on the target analysis data to detect and annotate target influence variables associated with the target in the target analysis data.

In addition, the server computing system 130 may input the target and target influence variables into a causal graph generation model, which is trained to generate a causal graph between the target and the target influence variables based on the annotated target analysis data, thereby generating a causal graph at a semantic level.

Herein, the causal graph between the target and the target influence variables may include information defining the target and target influence variables at a semantic level in nodes along with node names.

For example, the information for determining the target and target influence variables at a semantic level may include additional annotations such as the name, keyword, source, domain, region, place, and characteristics of the corresponding elements.

In addition, the causal graph between the target and the target influence variables may include information about the causation about whether the mutual influence between each node (i.e. target and target influence variables) precedes or follows through arrows.

In an embodiment, the server computing system 130 may perform a process of collecting target analysis data based on context and outputting causal information between the target and the target influence variable based on the collected target analysis data through a retrieval augmented generation (RAG) model.

Through the process of generating the causal information according to an embodiment, the target influence variable may be clearly identified and defined at a semantic level by concepts, categories, topics, and/or specific criteria, so that the context and domain related to the target influence variable at the semantic level may be accurately determined.

Then, the information defined as such may be annotated to the target influence variable and utilized to perform data preparation at the semantic level later, so that the raw data necessary for target prediction may be accurately discriminated.

At step S105, when the causal information between the target and the target influence variable is determined, the server computing system 130 may perform data preparation based on the determined causal information.

First, the server computing system 130 may collect raw data related to the target influence variable and the target of the causal information for the outlook prediction of a target.

In an embodiment, the server computing system 130 may collect unstructured data (for example, news and analysis reports in the form of text, etc.) related to the target and the target influence variables and structured data through keyword searches indicating the target and target influence variables, and store the collected raw data in the data store.

In addition, the server computing system 130 may determine whether the raw data stored in the data store is related to the target influence variables at the semantic level (e.g., document identification) and extract the related data. In this connection, the raw data may be filtered according to whether it matches the semantic definition included in the target and the target influence variables, and the prediction basic data necessary for target prediction may be acquired.

For example, the server computing system 130 may input a document to be determined as input and output the relevance of the target influence variable at the semantic level as an operation, thereby extracting prediction basic data related to the target and the target influence variable at the semantic level from the raw data.

In order to identify data related to the target influence variable that affects the target, past data analysis knowledge and domain expertise in the target-related field may be important.

For this, the server computing system 130 may derive events related to the target and events unrelated to the target through a language model.

For example, the server computing system 130 may instruct the language model through a prompt for writing related/unrelated events that includes a phrase that instructs a user to operate as a domain expert for the target, thereby returning a plurality of associated events that affect the change of the target at the semantic level and a plurality of non-associated events that do not affect or have an effect below a reference value.

Specifically, an associated/non-associated event writing prompt may include information defining each target influence variable at the semantic level so as to instruct the language model to distinguish associated events and non-associated events that affect the target from the prediction basic data.

Then, the server computing system 130 writes a document identification prompt for classifying and identifying the prediction basic data from the raw data through the returned associated/non-associated events, and requests the language model to classify documents for the raw data based on the written document identification prompt, thereby accurately extracting the prediction basic data related to the target and the target influence variable.

In addition, the unstructured data related to the outlook of the target may be detected from the prediction basic data related to the target and/or the target influence variable. In other words, the server computing system 130 may classify documents associated with the target and/or the target influence variable from the raw data stored in the data store, and detect associated events and/or sentences that affect the target from the documents.

For example, a document classification prompt may be configured to 1) instruct the target to operate as an expert, 2) input at least one document included in the raw data to be identified as input data, 3) instruct to select one of the associated event options associated with the prediction of the target in the document and the non-associated event options that do not affect the target, and 4) add an associated event that affects the target among the information in the document to the associated event options or add a non-associated event that does not affect the target to the non-associated event options.

As a specific example, when an element to be predicted is “lithium production,” the server computing system 130 may identify whether document in raw data is related to “lithium production” through the prompt configured of <<1) Become a lithium expert. 2) Input: [document] 3) Classify [documents] related to the increase or decrease in lithium production. There are two options for your answer.—Option 1: Highly relevant (list of associated events),—Option 2: Not relevant (list of non-associated events), 4) First, describe the reason how the information provided in relation to lithium production increases or decreases. Then, place the option number on the last line.>>.

In other words, the server computing system 130 may collect raw data in relation to the target and/or target influence variables, classify prediction basic data related to the target and/or target influence variables from the raw data, and determine associated events and sentences that affect the outlook of the target from the classified prediction basic data, thereby filtering out sentences and associated events related to the target outlook from the raw data as unstructured data.

Next, the server computing system 130 may identify and classify whether each feature stored in the data store belongs to a related target influence variable (semantic variables) using a language model, and may generate a structured dataset configured of structured data for the related feature. The feature may mean an attribute of data stored in a structured data format as various factors that affect the outlook of the target, and may include, for example, CSV, Excel file, and/or database table.

For example, when the target is lithium price, the target influence variables refer to variables that have causation with lithium price, such as “spodumene, lithium mine, lithium salt lakes, lithium carbonate, lithium hydroxide, lithium battery,” and the features may be structured data that belongs to the target influence variables and affects the outlook of the target, such as “Australian spodumene production, Australian spodumene exports, Chilean lithium hydroxide production, Chilean lithium hydroxide exports, Chinese spodumene imports, Chinese lithium carbonate imports, Chinese lithium carbonate production, Chinese lithium carbonate sales, lithium battery efficiency (km/wh), Chinese electric vehicle sales, and Chinese electric vehicle subsidy plan.”

In other words, in an embodiment, the target influence variables may be specific concepts, topics, or categories that affect the target outlook, and the features may refer to attributes of structured data in the data storage related to the target influence variables.

In addition, the server computing system 130 may filter out relevant features related to target influence variables among the features of the data store and integrate the filtered features to the generated structured dataset.

The process of generating the structured dataset according to an embodiment of the present disclosure may be described as follows.

The server computing system 130 may list features that may be used in the data store by a feature name. In addition, a description for each feature may be listed together.

In addition, the server computing system 130 may filter features related to target influence variables that may affect the target among the listed features based on the association with the target influence variables defined at the semantic level.

To this end, the server computing system 130 may utilize a machine learning model or a language model that classifies the relevance between features and target influence variables.

In an embodiment, the server computing system 130 may list the feature names and descriptions of the data store, input the keywords of the target influence variables of the causal information into a word embedding model, and detect the feature names associated with the keywords of each target influence variable according to feature relevance, thereby mapping the features classified into each target influence variable. The word embedding may mean a model trained to classify features relevant to semantic target influence variables based on feature names and descriptions.

In addition, the server computing system 130 may generate a time-series structured data format (for example, csv, excel, and the like) by obtaining structured data (e.g., tubular data) corresponding to the name of the classified feature from the data store, organizing and pre-processing the obtained structured data, and arranging the structured data into a structured format and processing the structured data so as to be suitable for input into target prediction modeling.

As such, the server computing system 130 may collect accurate raw data that serves as the basis for target prediction based on the causal information between the target and the target influence variables, and may precisely filter the structured data and unstructured data necessary for the target prediction from the collected raw data and utilize the filtered structured data and unstructured data as input data for target prediction modeling.

Next, at step S107 the server computing system 130 may generate quantitative data by quantifying the unstructured data (Text Processing for Forecasting).

First, the server computing system 130 may generate prediction scoring data by scoring target prediction values for each target outlook report for the target outlook reports that predict target outlook among the documents classified as unstructured data.

In an embodiment, the server computing system 130 inputs each target outlook report into a language model, performs sentiment analysis on the associated sentences classified as target outlook predictions, classifies the target outlooks into positive, neutral, and negative, and operates according to the target outlook scoring prompt that returns a numerical value of the tone level, thereby listing the prediction scoring data in chronological order to generate quantitative data.

Specifically, the returned target outlook scoring prompt may be configured to classify opinions on the target outlook from the input text into positive, neutral or negative when a target outlook report (or, associated sentences related to the target outlook extracted from the target outlook report) is input, and select a tone for the outlook opinion from the input text within a predetermined level range.

In addition, the server computing system 130 may generate an event list based on associated events that affect the outlook of the target detected in documents during unstructured data filtering.

For example, the server computing system 130 may generate an event list that quantifies the occurrence date of an event affecting the outlook of the target, related features, values of related features, and impact and influence that affected the outlook of the target as quantitative data.

In addition, the server computing system 130 may encode each document classified as unstructured data into a latent vector through the encoder of the language model and return an embedding matrix. Specifically, the server computing system 130 may obtain an embedding matrix that captures the semantic essence of each document by encoding the document into the latent vector using the language model.

In detail, the server computing system 130 may input documents, such as news, among unstructured data, into the encoder of the language model to generate document embedding metrics for modeling topics prevalent in each document. The generated document embeddings generated may highlight topics (e.g., variables and features) that may affect the future outlook of the target by identifying topics prevalent in the document using an algorithm such as Latent Dirichlet Allocation (LDA).

Thereafter, at step S109, the server computing system 130 may predict the target outlook based on the generated structured dataset and quantitative data.

In detail, the server computing system 130 may calculate an outlook value of a target for each prediction unit period during the total outlook period based on the quantitative data and the structured dataset.

To this end, the server computing system 130 may generate an integrated structured dataset by concatenating the structured dataset generated based on the structured data and the quantitative dataset generated based on the unstructured data.

Specifically, the server computing system 130 may first classify the data according to the influence that affects the target, and then concatenate the data by assigning weights.

For example, the server computing system 130 may classify variables that affect the target more than the reference value among the features included in the structured dataset as macro variables, and classify variables that affect the target less than the reference value as micro variables.

In addition, the server computing system 130 may match the classified macro variables and quantitative data in a time series manner and then integrate the matched classified macro variables and quantitative data into one macro time series structured dataset, and may integrate the data classified into micro variables into one micro time series structured dataset.

In other words, in an embodiment, an integrated structured dataset including both structured data information and unstructured data information may be generated by matching and concatenating the event list and prediction scoring data according to the time series flow of the structured dataset.

In addition, the server computing system 130 may input the generated integrated structured dataset into a prediction model to compute the outlook value of the target for each prediction unit period during the total outlook period. The prediction model may include, for instance, but not limited to, linear regression, decision tree, random forest, gradient boosting, deep learning model, and/or pre-trained language model.

In an embodiment, the server computing system 130 may additionally input causal information at a semantic level into the prediction model to induce prediction of target outlooks according to the causal information.

In addition, in an embodiment, the server computing system 130 may input the embedding metrics into a second prediction model that predicts a target outlook based on the embedding metrics, so as to reflect unstructured target prediction information that is not in structured data into a prediction value.

Specifically, in an embodiment, the server computing system 130 may input an integrated structured dataset into a first prediction model to primarily compute a first target outlook value.

In addition, the server computing system 130 may regulate the first target outlook value based on the semantic causal graph to compute a second target outlook value reflecting the causal information between the target influence variable and the target.

Finally, the server computing system 130 may calibrate the computed second target outlook value based on the unstructured target prediction information to finally compute a final target outlook value.

In addition, at step S111, the server computing system 130 may generate basis information by interpreting the basis for the target outlook based on the causal information and the structured dataset.

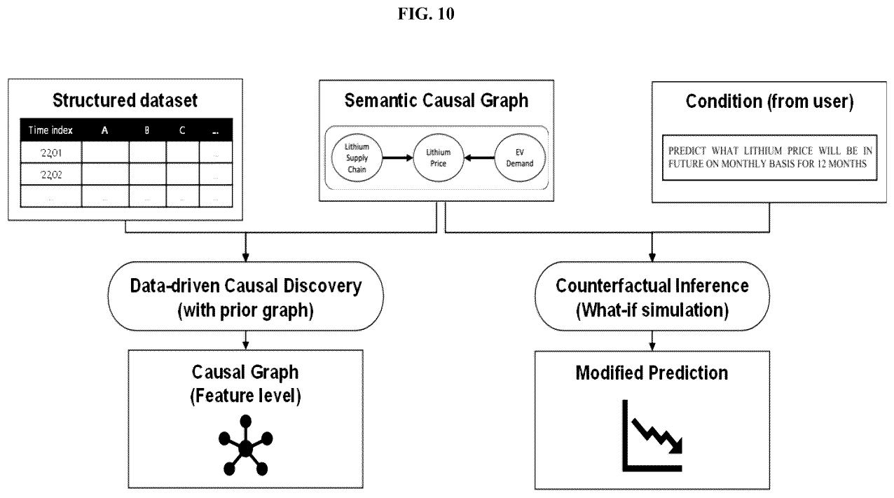

Referring to FIG. 10, the server computing system 130 may interpret the basis for the final target outlook value based on the causal information at a semantic level and the structured dataset to output basis information.

Specifically, the server computing system 130 may generate a past causal graph at a feature level based on the past existing target value, the structured dataset, and the semantic causal graph based on the present from the structured dataset.

In addition, the server computing system 130 may generate a future causal graph at the feature level based on a causal discovery model (e.g., Data-driven Causal Discovery) trained from the future final target outlook value, structured data set and semantic causal graph with the past causal graph based on the present.

In addition, the server computing system 130 may provide the future causal graph by being mapped to a target outlook value, thereby providing basis information about how the target outlook value was computed because features have an influence to some extent on the target outlook value.

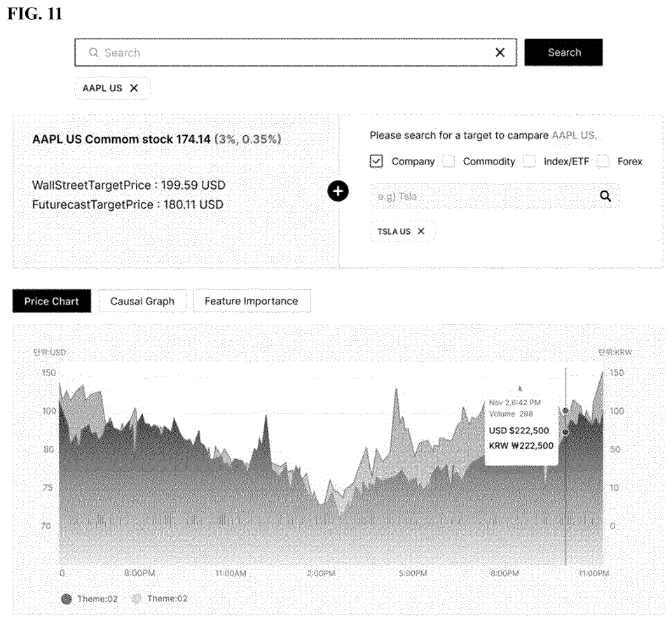

For example, referring to FIG. 11, the server computing system 130 may provide a target outlook graph representing the target outlook value computed for each prediction unit period during the total outlook period through the user computing device 110.

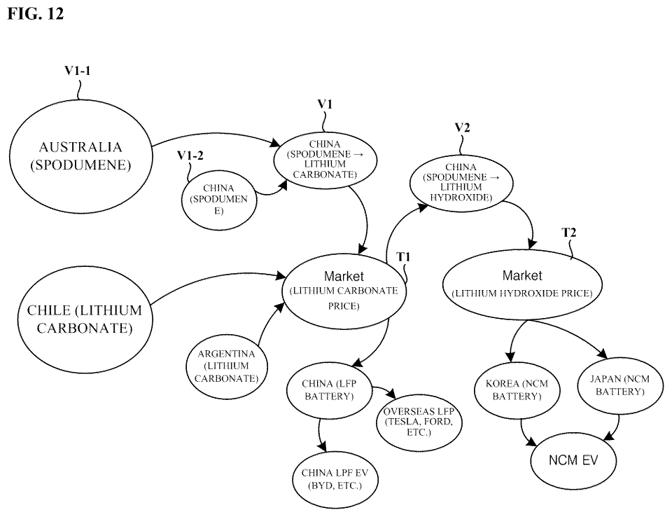

In addition, referring to FIG. 12, the server computing system 130 may provide a causal graph at the feature level that interprets the basis for predicting the target outlook value as basis information through the user computing device 110.

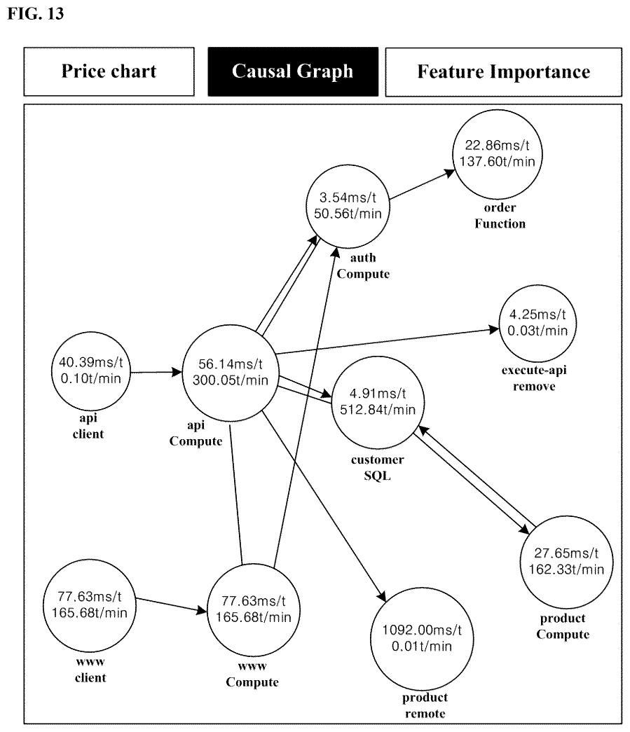

In particular, referring to FIG. 13, the server computing system 130 may further enhance user reliability for the target outlook by displaying specific numerical values of features that affected the predicted target outlook value at a specific prediction point in time.

At step S113, the server computing system 130 may provide target outlook values and basis information in a changed environment (e.g., a what-if situation) by re-performing a what-if simulation according to the input prediction environment change after receiving input of a prediction environment change from a user after providing the computed final target outlook value and basis information.

Specifically, referring to FIG. 10, a user may input a change in the prediction environment by changing a feature of a target influence variable that affects the target outlook value or inputting a specific event occurrence through the user computing device 110.

In an embodiment, when there is a change in the target influence variable, the server computing system 130 may re-execute the process of interpreting the target outlook value and basis information after changing the integrated structured data set according to the changed target influence variable, output a target outlook value and basis information according to a simulation, and provide the target outlook value and basis information output by the simulation to the user computing device 110.

In another embodiment, the server computing system 130 may receive input for a change in the predicted environment according to the occurrence of a specific event. In this connection, the server computing system 130 may quantitatively reflect the occurrence of a specific event in an event list, and then, after computing the changed quantitative data, change the integrated structured data set based on the changed quantitative data, and then re-execute the process of interpreting the target outlook value and basis information, and output the target outlook value and basis information according to the simulation, and provide the target outlook value and basis information output by the simulation to the user computing device 110.

In addition, although the detailed description of the present disclosure has been described with reference to preferred embodiments of the present disclosure, it will be understood that those skilled in the art or those with ordinary knowledge in the art can modify and change the present disclosure in various ways without departing from the spirit and technical scope of the present disclosure described in the claims below. Accordingly, the technical scope of the present disclosure should not be limited to the contents described in the detailed description of the specification, but should be defined by the claims.

Some embodiments of the present disclosure may be directed to a method and system for predicting a future outlook for a target by analyzing structured and unstructured data at a semantic level, and thus have industrial applicability.

What is claimed is:

1. A computerized method comprising:
receiving a predictive generation request from a user to execute a predictive generation task;
determining a predictive generation element based on the received predictive generation request;
generating causal relationship information between a target of the determined predictive generation element and a target influence variable of the target at a semantic level;
collecting raw data based on the generated causal relationship information between the target and the target influence variable and storing the collected raw data in a data store;
generating a structured data set by determining features related to the target and the target influence variable from the raw data stored in the data store and integrating structured data corresponding to the determined features;
generating quantification data by quantifying unstructured data from the collected raw data;
generating an integrated structured data set based on the generated structured data set and the quantification data; and
computing a target outlook value predicting a future outlook value of the target based on the generated integrated structured data set.

2. The computerized method of claim 1, wherein the determining of the predictive generation element comprises:
inputting a query generation prompt template preset based on the predictive generation request to a language model configured to perform named entity recognition (NER); and
receiving values corresponding to the target, a total outlook period, and a prediction unit period from the language model.

3. The computerized method of claim 1, wherein the generating of the causal relationship information comprises:
detecting target analysis data for the target of the determined predictive generation element; and
generating the causal relationship information representing a causal relationship between the target and the target influence variable based on the detected target analysis data at the semantic level.

4. The computerized method of claim 3, wherein the detecting of the target analysis data comprises detecting a target analysis report that analyzes the target by inputting a target keyword for the target into a language model and performing keyword search based on the target keyword.

5. The computerized method of claim 3, wherein the generating of the causal relationship information representing the causal relationship between the target and the target influence variable comprises:
detecting the target influence variable associated with the target by performing topic-relevant terms recognition on the target analysis data, and annotating the target analysis data with the detected target influence variable; and
inputting the annotated target analysis data into a causal relationship graph generation model to receive a causal relationship graph at the semantic level from the causal relationship graph generation model.

6. The computerized method of claim 1, wherein the generating of the causal relationship information between the target and the target influence variable comprises collecting target analysis data based on context and outputting the causal relationship information between the target and the target influence variable based on the collected target analysis data through a retrieval augmented generation (RAG) model.

7. The computerized method of claim 5, wherein the collecting of the raw data comprises searching for the raw data based on information for determining the target influence variable at the semantic level included in the causal relationship information.

8. The computerized method of claim 7, wherein the generating of the quantification data by quantifying the unstructured data comprises:
inputting a document of the raw data into a document classification prompt template and determining whether the input document of the raw data is a document that affects the target through a language model; and
including the document of the raw data, determined as the document that affects the target, as prediction basic data.

9. The computerized method of claim 8, wherein the document classification prompt template is configured to add an operation instruction for instructing to operate as a domain expert for the target, inputting the document of the raw data to be identified as input data, and selecting, from the document of the raw data, one of an associated event option associated with prediction of the target or a non-associated event option that does not affect the target, and to add an associated event that affects the target among information of the document of the raw data to the associated event option or to add a non-associated event that does not affect the target to the non-associated event option.

10. The computerized method of claim 1, wherein the integrating of the structured data corresponding to the determined features comprises:
identifying features stored in the data store with feature names and descriptions;
classifying whether each of the features stored in the data store is associated with each of a plurality of target influence variables at the semantic level based on the feature names and the descriptions;
extracting structured data of a feature having a feature name associated with each of the plurality of target influence variables; and
integrating the extracted structured data of the feature having the feature name associated with each of the plurality of target influence variables based on a time series to generate the structured data set.

11. The computerized method of claim 10, wherein the classifying of whether each of the features stored in the data store is associated with each of the plurality of target influence variables at the semantic level comprises:
determining feature relevance between each of the plurality of target influence variables and the features stored in the data store through a machine learning model; and
classifying one or more features of which feature relevance is greater than or equal to a reference value as one of the plurality of target influence variables.

12. The computerized method of claim 1, wherein the generating of the quantification data by quantifying the unstructured data comprises:
detecting one or more target outlook reports predicting an outlook of the target from the unstructured data;
classifying the outlook of the target as positive, neutral, or negative for each of the one or more target outlook reports by performing sentiment analysis on sentences predicting the target in the one or more target output reports using a language model;
quantifying a level of a tone of the classified outlook of the target and outputting the level of the tone of the classified outlook of the target as predicted scoring data; and
listing the predicted scoring data of the one or more target outlook reports in chronological order and generating the predicted scoring data of the one or more target outlook reports as quantitative data.

13. The computerized method of claim 1, wherein the generating of the quantification data by quantifying the unstructured data comprises:
detecting an associated event that affects an outlook of the target from the unstructured data; and
generating an event list that quantifies an occurrence date of the associated event, a related feature, a value of the related feature, and impact and influence that affected the outlook of the target as the quantification data.

14. The computerized method of claim 1, wherein the generating of the quantification data by quantifying the unstructured data comprises inputting documents of the unstructured data into an encoder of a language model to generate document embedding metrics to model a topic that each of the documents of the unstructured data represents.

15. The computerized method of claim 1, wherein the generating of the integrated structured data set based on the generated structured data set and the quantification data comprises matching and concatenating the integrated structured data set generated based on the structured data and the quantification data generated based on the unstructured data according to a time series.

16. The computerized method of claim 15, wherein the computing of the target outlook value predicting the future outlook value of the target comprises predicting the target outlook value of a future by inputting the integrated structured data set into a prediction model.

17. The computerized method of claim 16, wherein the predicting of the target outlook value of the future comprises:
inputting the integrated structured data set into a first prediction model to compute a first target outlook value; and
adjusting the computed first target outlook value based on the causal relationship information between the target and the target influence variable to compute a second target outlook value.

18. The computerized method of claim 16, wherein the predicting of the target outlook value of the future comprises:
inputting documents of the unstructured data into a language model encoder to generate document embedding metrics for each of the documents of the unstructured data;
inputting the document embedding metrics into a second prediction model to generate unstructured predictive generation information; and
calibrating the second target outlook value based on the unstructured predictive generation information to compute a final target outlook value.

19. The computerized method of claim 1, further comprising:
inputting the target outlook value of a future and the structured data set into a causal relationship discovery model trained using a past causal relationship graph and a predictive generation outlook to output a future causal relationship graph at a feature level; and
providing a previously generated future causal relationship graph as an outlook basis for the target outlook value.

20. A system comprising:
a data store configured to store predictive generation-related data;
memory configured to store instructions and data for performing a predictive generation task; and
at least one processor configured to perform the predictive generation task according to the instructions and data stored in the memory,
wherein the at least one processor is configured to:
receive a predictive generation request from a user to execute the predictive generation task;
determine a predictive generation element based on the received predictive generation request;
generate causal relationship information between a target of the determined predictive generation element and a target influence variable of the target at a semantic level;
collect raw data based on the generated causal relationship information between the target and the target influence variable;
generate a structured data set based on structured data of a feature related to the target influence variable from the collected raw data;
generate quantification data by quantifying unstructured data from the collected raw data;
generate an integrated structured data set based on the generated structured data set and the quantification data; and
compute a target outlook value predicting a future outlook value of the target based on the generated integrated structured data set.
